(19) United States
(12) Patent Application Publication
(10) Pub. No.: US 2002/0135671 A1
(43) Pub. Date: Sep. 26, 2002

(54) Image telecommunication system for personal digital assistant and a control method thereof

(76) Inventor: Do-Seung Yang, Seoul (KR)

Correspondence Address: HARNESS, DICKEY & PIERCE, P.L.C., P.O. BOX 8910, RESTON, VA, 20195, US

(21) Appl. No.: 10/035,049

(22) Filed: Dec. 28, 2001

(30) Foreign Application Priority Data
Mar. 26, 2001 (KR) 2001-15604

(51) Int. Cl. H04N 7/14

(52) U.S. Cl. 348/14.01; 348/14.13

(57) ABSTRACT

Disclosed is a videophone terminal system which comprises: a camera for capturing a user's image and outputting it; a case system, in which the camera is installed, for interfacing output signals of the camera, converting input and output signals into wireless signals, and transmitting and receiving the same; and an information terminal for compressing image signals input by the case system and voice signals input by an internal microphone, controlling them to be transmitted to a corresponding connected person through the case system, restoring received image and voice signals, and outputting them. Therefore, users can conveniently use videophone services.

### BACKGROUND OF THE INVENTION

(a) Field of the Invention

The present invention relates to an image communication terminal system and a control method thereof. More specifically, the present invention relates to an image communication terminal system and a control method thereof for videophone and data communication on the basis of the H.323 protocol.

(b) Description of the Related Art

In general, personal digital assistants (PDAs) are mainly used for providing personal information management (PIM) functions such as an electronic purse, for storing address lists and memos, schedule management, and for reproducing music using an MP3 player.

Recently, users' requests for information communication have increased, and the users have desired portable terminals with various functions including navigating the Internet, communicating via electronic mail or fax, and calling using the PDA, and accordingly, image/voice calling by the IMT-2000 will be implemented in the near future.

As described, the need for a PDA having the image/voice calling function desired by the users has gradually increased, but a PDA that satisfies these needs has not yet been manufactured.

In detail, the H.323 protocol has been established by the ITU in order to connect personal computers with common telephone networks. The conventional stacks (or libraries) for supporting the H.323 have already been developed and managed on the PC basis (Windows and Linux).

However, the stacks (or libraries) for supporting the H.323 in the PDAs (on the basis of WinCE) and mobile terminals have not been developed. Also, since in the conventional wireless communication terminals through which the PDAs use the CDMA method, the CDMA terminal and the digital camera with a compact flash (CF) interface cannot be simultaneously used, and therefore, the video phone function cannot be implemented between PDAs, between a PDA and a PC, and between a PDA and a videophone.

### SUMMARY OF THE INVENTION

It is an object of the present invention to provide a videophone terminal system and a control method for implementing videophone communication between PDAs, between a PDA and a PC, and between a PDA and a videophone, and improving the convenience of PDA usage.

It is another object of the present invention to implement H.323 stacks on a PDA basis (WinCE) so as to link a PDA to conventional communication network service providers (e.g., 019, 011, 016, 017, and 018 phone-numbered communication network service providers) using a wireless network, and to implement videophone communication between PDAs, between a PDA and a PC, and between a PDA and a videophone, and to be convertible with the communication network service providers.

It is still another object of the present invention to provide a PDA extension pack for concurrently supporting a CF interface in which a digital camera is installed and a CDMA module interface that supports the 95C network.

It is still another object of the present invention to concurrently provide a CDMA interface and a CF interface so that data communication using the CDMA method and image data capturing using the CF interface may be concurrently used.

It is a further object of the present invention to access a public switched telephone network (PSTN) through a CDMA module accessed to a PDA and to use a digital camera, a recorder, and a speaker between users so as to provide a videophone service for transmitting and receiving images and voices.

In one aspect of the present invention, a videophone terminal system comprises: a camera for capturing a user's image and outputting it; a case system, in which the camera is installed, for interfacing an output signal of the camera, converting input and output signals into wireless signals, and transmitting and receiving the same; and an information terminal for compressing image signals input by the case system and voice signals input by an internal microphone, controlling them to be transmitted to a corresponding connected person through the case system, restoring received image and voice signals, and outputting them.

In another aspect of the present invention, a videophone terminal system comprises: a camera for capturing a user's image and outputting it; and an information terminal in which the camera is installed, for compressing image signals input by the camera and voice input by an internal microphone, converting them, wirelessly transmitting them, restoring image and voice signals received from the outside, and outputting them, the information terminal comprising: an interface for interfacing output signals of the camera; a microphone for receiving voice and outputting it; an image and voice compressor for receiving voice and image signals from the microphone and the interface, compressing them, and outputting them; a controller for controlling to transmit the images and voice compressed by the image and voice compressor through a wireless network, and controlling to restore received signals; a modem for converting compressed signals output by the controller through the interface to fit wireless environments, converting received wireless signals to fit wire environments, and outputting them to a controller through the interface; an antenna for wirelessly radiating signals output through the modem; an image and voice restorer for restoring the compressed signals according to control by the controller; a speaker for outputting voice restored by the image and voice restorer; and a display for displaying images restored by the image and voice restorer.

In still another aspect of the present invention, a method for controlling a videophone terminal system comprises: a compact flash type camera capturing a user's image and outputting it; an information terminal receiving output signals from the camera and voice signals from the microphone, compressing the image signals through an H.263 (video CODEC) and the voice signals through a G732.1 (audio CODEC); and a wireless modem of a case system converting the compressed signals into s wireless signals and transmitting them.

### BRIEF DESCRIPTION OF THE DRAWINGS

The accompanying drawings, which are incorporated in and constitute a part of the specification, illustrate an embodiment of the invention, and, together with the description, serve to explain the principles of the invention:

FIG. 1 shows a videophone terminal system according to a first preferred embodiment of the present invention;

FIG. 2 shows an outer appearance of the videophone terminal system according to a first preferred embodiment of the present invention;

FIG. 3 shows a video communication process;

FIG. 4 shows a flowchart for controlling the videophone terminal system according to a first preferred embodiment of the present invention;

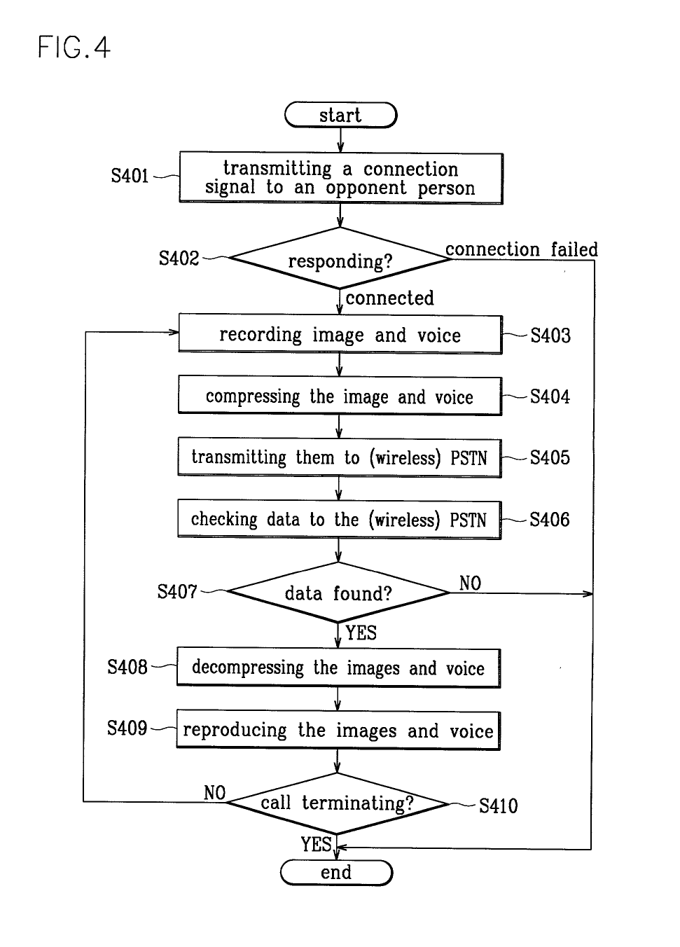

FIG. 5 shows a videophone terminal system according to a second preferred embodiment of the present invention; and

FIG. 6 shows an outer appearance of the videophone terminal system according to a second preferred embodiment of the present invention.

### DETAILED DESCRIPTION OF THE PREFERRED EMBODIMENTS

In the following detailed description, only the preferred embodiment of the invention has been shown and described, simply by way of illustration of the best mode contemplated by the inventor(s) of carrying out the invention. As will be realized, the invention is capable of modification in various obvious respects, all without departing from the invention. Accordingly, the drawings and description are to be regarded as illustrative in nature, and not restrictive.

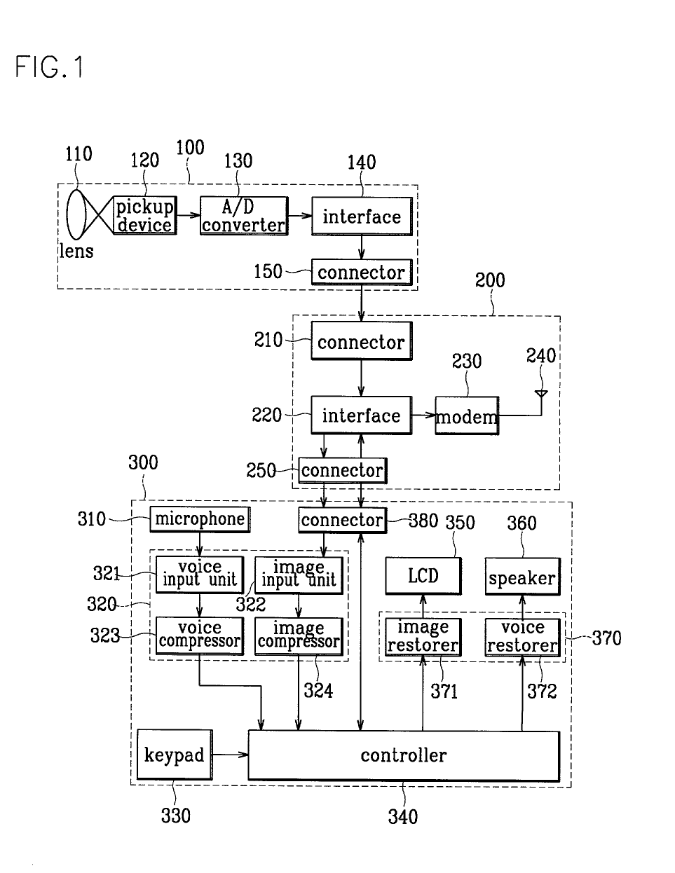

FIG. 1 shows a videophone terminal system according to a first preferred embodiment of the present invention.

As shown, the videophone terminal system comprises a camera 100, a case system 200 and an information terminal 300.

The camera 100 captures a user's image and outputs it. The case system 200, equipped with the camera 100, interfaces the camera's output signals, converts input/output signals into wireless signals and transmits and receives them. The information terminal 300 compresses image signals input by the case system 200 and voice signals input through an internal microphone, controls them to be transferred to a connected user via the case system 200, restores received image and voice signals, and outputs restored signals.

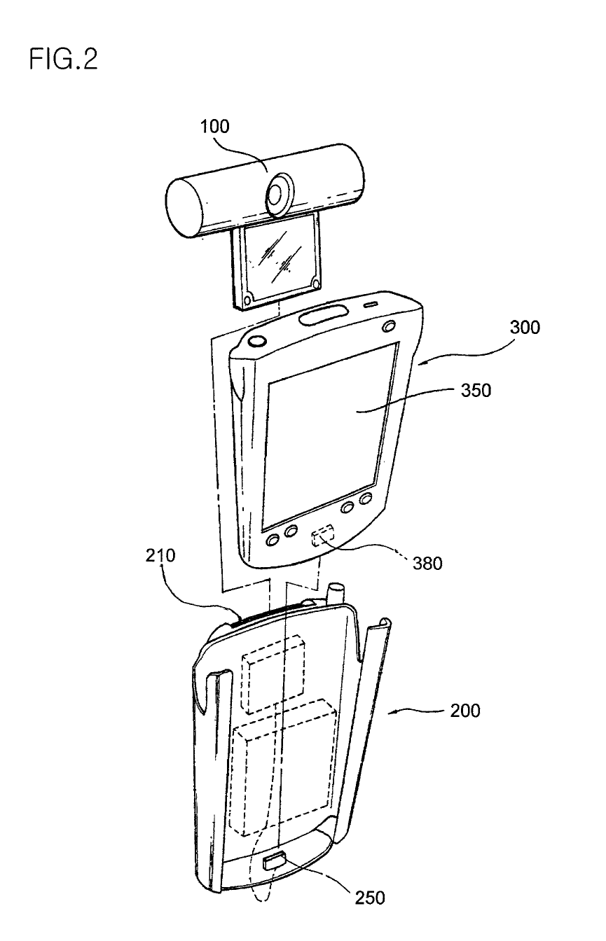

FIG. 2 shows an outer appearance of the videophone terminal system according to a first preferred embodiment of the present invention.

Referring to FIG. 2, the videophone terminal system comprises an information terminal 300 including a liquid crystal display (LCD) 350 and a connector 380; and a case system 200 formed to receive and fix the information terminal 300, including a connector 250 for connection with the information terminal 300. A digital camera 100 having a CF-type image data capturing function is installed on a connector 210 of a CF-type slot format, formed on a top portion of the case system 200, and a microphone 310 and a speaker 360 are installed in the information terminal 300.

A compact flash interfaces the digital camera 100 and the information terminal 300.

An operation of the videophone terminal system will now be described.

Initially, a user manipulates a keypad 330 of the information terminal 300 to execute a video call with another person.

Transmission information is transmitted by control of a controller 340 through an interface 220, a modem 230, and an antenna 240 in step S401. The transmission information is transmitted to a corresponding service provider through a CDMA network 13 and a PSTN 40, and is then transmitted to the other person's videophone or information terminal according to control by the service provider.

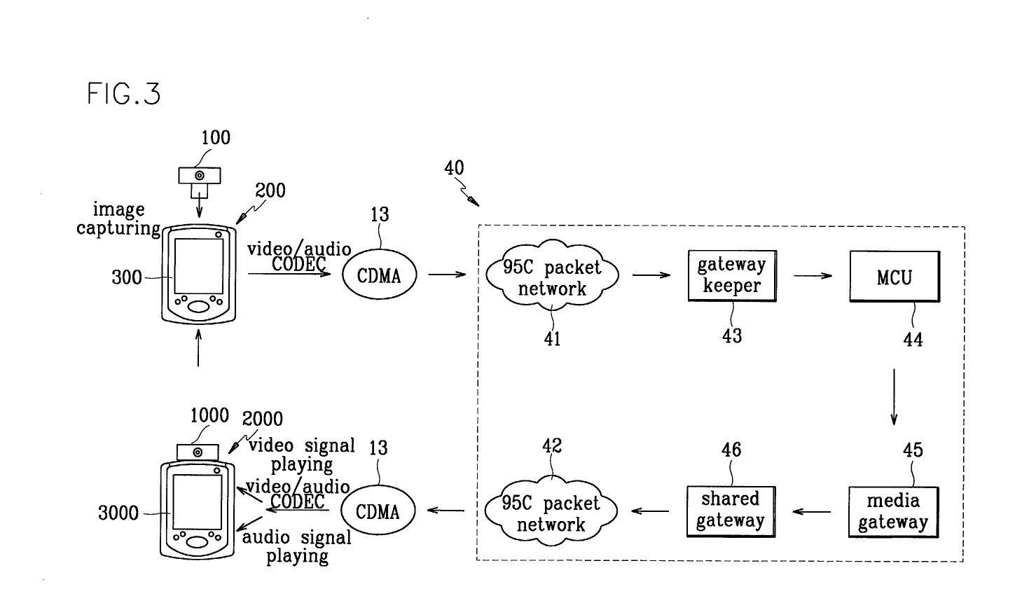

Referring to FIG. 3, the prior art PSTN 40, that is, an H.323/CDMA data network, comprises 95C networks 41 and 42; a gateway keeper 43; a multi-point conference controller (MCU) 44; a media gateway 45; and a shared gateway 46.

When receiving a corresponding signal, a recipient is connected to a call by allowing the signal to go through. That is, when the person responds to a call connection signal, the call is connected in step S402.

The CF-type digital camera 100 having an image data capturing function captures the user's images, and a lens 110 outputs color components of an object in the light format. A pickup device 120 converts the light into electrical charges, temporarily stores the same and outputs them as electrical signals. An analog/digital (A/D) converter 130 converts the electrical signals into digital signals, and an interface 140 interfaces digital image signals to an interface 220 of the case system 200 through connectors 150 and 210.

After this, the interface 220 interfaces the image signals to an image input unit 322 through the connectors 250 and 380. The image input unit 322 converts the image signals into a format to be processed by the information terminal 300 through a device driver in step S403. An image compressor 324 compresses the input image signals through the H.263 (video coder/decoder (CODEC)) in step S404.

The microphone 310 in the information terminal 300 receives the user's voice and outputs the same as voice signals. A voice input unit 321 receives the voice signals and converts them into a format to be processed by the information terminal 300 in step S403. A voice compressor 323 compresses the voice input by the microphone 310 through the G.732.1 (audio CODEC). In this instance, a voice and image compressor unit 320 has recording and reproducing functions, and the information terminal 300 uses the digital camera 100 to capture image data at 15 to 20 frames per second, and records voice input through the microphone 310 of the PDA 20. The above-noted voice compression function using the G732.1 is improved from the conventional G.732.1/G.723 CODEC method, compression time is improved to 10 to 12 ms from the existing time of 35 to 40 ms, and decoding time is improved to 0.5 ms from the existing time of 1 ms. The image compression function using the H.263 is improved from the existing H.261 recommendation by removing duplication of time direction using motion estimation and compensation and by removing duplication of space direction using conversion coding. An input ratio stream buffer and an output ratio stream buffer in the PDA assign about 26 kB, and an image buffer uses 760 kB to store 20 frames and automatically adjusts transmission amount according to the wireless network states, thereby adding a function of transmitting more image frames.

When the image compressor 324 and the voice compressor 323 respectively output compressed image and voice signals, the controller 340 transmits the compressed signals to the modem 230 through the connectors 380 and 250 and the interface 220. When receiving the compressed signals, the modem 230 transmits data to the PSTN 40, that is, the H.323/CDMA data network, through the antenna 240 in a wireless communication method (TCP/IP) in step S405.

After this, the connected person checks whether data exists in step S406, decompresses the images and the voice, reproduces the image and voice data using reproduction software executed by the information terminal, and the data are then transmitted according to the above-described transmission process.

The compressed signals transmitted by the connected person are transmitted to the modem through the antenna 240 in step S407, and the modem 230 converts the compressed signals to fit wire environments and outputs the converted signals to the controller 340 through the interface 220. The controller 340 transmits the corresponding compressed signals to an image and voice restoration unit 370 to restore the compressed signals.

An image restorer 371 restores the compressed image signals through the H.263 (video CODEC) and outputs them to an LCD 350 in step S408. A voice restorer 372 restores the compressed voice signals through the G732.1 (audio CODEC) and outputs them to the speaker 360 in step S408. Here, the compression and restoration functions of the image and voice signals can be executed using a single video and audio CODEC, and they can be modified by a skilled person.

Accordingly, the user can call another person and see their appearance in step S409. After this, when the user terminates the call in step S410, the camera 100 and the microphone do not receive images and voice.

As described above, when a transmission user calls a user who attempts to videophone and is connected to the user, the present invention captures and compresses images and voice in real-time and transmits them to the connected person via a wireless network, and the connected person receives the images and the voice and decompresses them to restore them as original images and voice, and accordingly, the images are displayed on a PDA screen and the voice is reproduced through a PDA speaker, and hence, the users can talk over the videophone without disconnection, as if in person.

The standard wireless communication function linked with the PSTN 40 implements the H.323, that is, the standard protocol of the wireless network configured by the wireless communication service providers such as 019, 011, 016, 017 phone-numbered service providers as software in the information terminal 300 so that users of different networks may perform videophone communication. That is, the standard wireless communication implements the H.323 stacks on the PDA (WinCE) basis, uses the wireless PSTN 40 to link the PDA 300 to the conventional communication networks and be compatible with the 019, 011, 016, 017, and 018 phone-numbered communication service providers so that the videophone function can be implemented between PDAs, between a PDA and a PC, and between a PDA and a videophone.

Also, the image and voice compression function implements the compression or the restoration of the image and voice signals input by a camera or a recorder through the H.263 (Video) and the G732.1 (Audio) into PDA software, and accordingly, the wireless network is configured to minimize the size of the image/voice data such that the actually transmitted images or voice are as if those generated are spoken in front of the user without disconnection.

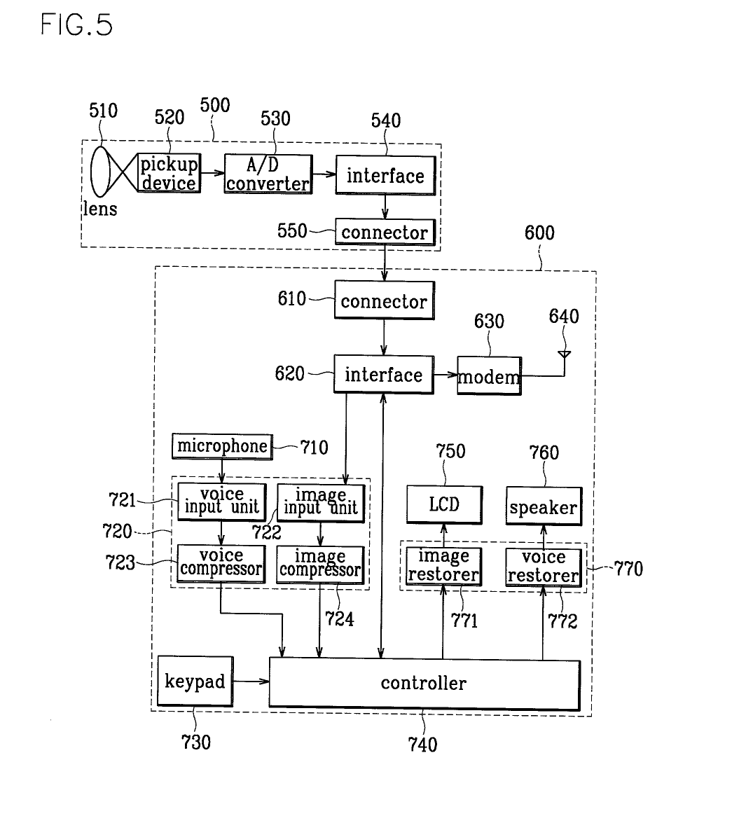

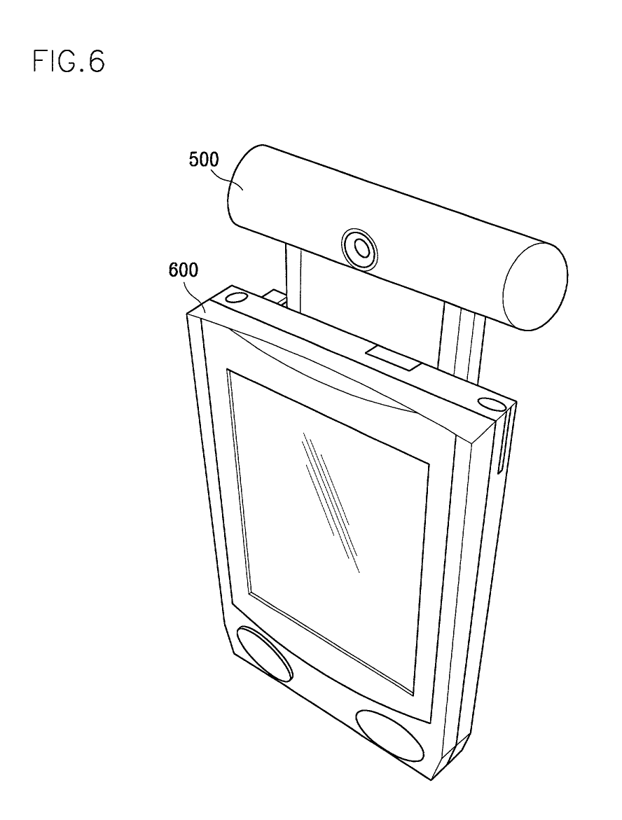

The first preferred embodiment can be variously modified by a skilled person, and a second preferred embodiment for implementing the present invention using an information terminal and a camera without a case system will now be described with reference to FIGS. 5 and 6.

FIG. 5 shows a videophone terminal system according to the second preferred embodiment of the present invention.

As shown, the videophone terminal system comprises a camera 500, an interface 620, a microphone 710, an image and voice compressor 720, a controller 740, a modem 630, an antenna 640, an image and voice restorer 770, a speaker 760, and an LCD 750.

The camera 500 captures the user's image and outputs it, and the interface 620 interfaces the output signal of the camera 500. The microphone 710 receives voice and outputs it. The image and voice compressor 720 receives voice and image signals from the microphone and the interface, compresses them and outputs them. The controller 740 controls the image and voice signals compressed by the image and voice compressor 720 to be transmitted via a wireless network, and controls received compressed signals to be restored. The modem 630 converts the compressed signals output by the controller 740 through the interface 620 into wireless environments, converts received wireless signals into wire environments, and outputs them to the controller 740 through the interface 620. The antenna 640 wirelessly radiates the signals output through the modem 630, and the image and voice restorer 770 restores the compressed signals according to control by the controller 740. The speaker 760 outputs the voice restored by the image and voice restorer 770, while the LCD 750 displays the images restored by the image and voice restorer 770.

The second preferred embodiment installs the interface 620, the modem 630, and the antenna 640 provided to the case system in the configuration of the first preferred embodiment in the information terminal. FIG. 6 shows the outer appearance of the second preferred embodiment.

Referring to FIG. 6, in the second preferred embodiment, the camera 500 is installed on the rear portion of the information terminal in the CF-type, and its outer appearance can be varied. Since the operation of the second preferred embodiment is identical with that of the respective units of the first preferred embodiment, no further description will be provided. In the second preferred embodiment, the video communication is enabled by using only the information terminal, and not the case system.

When the communication network expands to the IMT-2000, the present invention can be applied to the IMT-2000 communication network by upgrading the CDMA portion.

Since the videophone function can be possible through the PDA, the PDA user can manage personal information, navigate the wireless Internet and communicate with a desired person as if face-to-face at any time using the PDA. Also, the videophone function can be implemented between the PDAs, between the PDA and the PC, and between the PDA and the videophone. Further, since the present invention provides a PDA case system that concurrently supports the CF interface in which a digital camera is installed and the CDMA module interface that supports the 95C network and hence concurrently supports the CDMA and the CF interface, the data communication process using the CDMA and the image data capturing process using the CF interface can be used simultaneously.

While this invention has been described in connection with what is presently considered to be the most practical and preferred embodiment, it is to be understood that the invention is not limited to the disclosed embodiments, but, on the contrary, is intended to cover various modifications and equivalent arrangements included within the spirit and scope of the appended claims.

What is claimed is:

1. A videophone terminal system comprising:
a camera for capturing a user's image and outputting it;
a case system, in which the camera is installed, for interfacing an output signal of the camera, converting input and output signals into wireless signals, and transmitting and receiving the same; and
an information terminal for compressing image signals input by the case system and voice signals input by an internal microphone, controlling them to be transmitted to a corresponding person through the case system, restoring received image and voice signals, and outputting them.

2. The system of claim 1, wherein the case system comprises:
an interface for interfacing output signals of the camera;
a modem for converting compressed signals output by the information terminal through the interface to fit wireless environments, converting received wireless signals to fit wire environments, and outputting them to a controller through the interface; and
an antenna for wirelessly radiating signals output through the modem, and transmitting received wireless signals to the modem.

3. The system of claim 1, wherein the information terminal comprises:
a microphone for receiving voice and outputting it;
an image and voice compressor for receiving voice and image signals from the microphone and an interface, compressing them, and outputting them;
a controller for controlling to transmit images and voice compressed by the image and voice compressor through a wireless network, and controlling to restore received signals;
an image and voice restorer for restoring the compressed signals according to control by the controller;
a speaker for outputting voice restored by the image and voice restorer; and
a display for displaying images restored by the image and voice restorer.

4. The system of claim 1, wherein an image and voice compressor compresses image signals through an H.263 (video coder/decoder (CODEC)), and compresses voice signals through a G732.1 (audio CODEC).

5. The system of claim 1, wherein the camera is a compact flash type.

6. The system of claim 5, wherein the camera comprises:
a lens for outputting color components of an object in the light form;
a pickup device for converting the light into electrical charges, temporarily storing them, and outputting them as electrical signals;
an analog/digital (A/D) converter for converting the electrical signals into digital signals; and
an interface for interfacing the digital signals to the case system.

7. A videophone terminal system comprising:
a camera for capturing a user's image and outputting it; and
an information terminal in which the camera is installed, for compressing image signals input by the camera and voice input by an internal microphone, converting them, wirelessly transmitting them, restoring image and voice signals received from the outside, and outputting them, the information terminal comprising:
an interface for interfacing output signals of the camera;
a microphone for receiving voice and outputting it;
an image and voice compressor for receiving voice and image signals from the microphone and the interface, compressing them, and outputting them;
a controller for controlling to transmit the images and voice compressed by the image and voice compressor through a wireless network, and controlling to restore received signals;
a modem for converting compressed signals output by the controller through the interface to fit wireless environments, converting received wireless signals to fit wire environments, and outputting them to a controller through the interface;
an antenna for wirelessly radiating signals output through the modem;
an image and voice restorer for restoring the compressed signals according to control by the controller;
a speaker for outputting voice restored by the image and voice restorer; and
a display for displaying images restored by the image and voice restorer.

8. A method for controlling a videophone terminal system comprising:
a compact flash type camera capturing a user's image and outputting it;
an information terminal receiving output signals from the camera and voice signals from a microphone, compressing the image signals through an H.263 (video CODEC) and the voice signals through a G732.1 (audio CODEC); and
a wireless modem of a case system converting the compressed signals into wireless signals and transmitting them.

9. The method of claim 8, wherein the method further comprises: restoring image signals through an H.263 (video CODEC) and voice signals through a G732.1 (audio CODEC) when compressed image and voice signals are wirelessly received from the outside, and outputting them.
